(19) United States
(12) Patent Application Publication
(10) Pub. No.: US 2026/0087303 A1
(43) Pub. Date: Mar. 26, 2026

(54) METHOD AND SYSTEM FOR AUTOMATING CHAT-BASED INTERACTIONS

(71) Applicant: Honeywell International Inc., Charlotte, NC (US)

(72) Inventors: Vijay Kumar Ravi, Atlanta, GA (US); Pavan Ravindra Chhatpar, Sandy Springs, GA (US); Jan Zirnstein, Atlanta, GA (US); Sumanth Chitikireddy, suwanee, GA (US); Alpesh Desai, Alpharetta, GA (US); Brian Lau, Senoia, GA (US)

(21) Appl. No.: 18/892,601

(22) Filed: Sep. 23, 2024

(51) Int. Cl. G06N 3/042; G06N 3/0475

(52) U.S. Cl. CPC G06N 3/042; G06N 3/0475

(57) ABSTRACT

A system and method for automating chat-based interactions utilizing a large language model (LLM) is disclosed. The method involves receiving one or more requests from a user through an apparatus designed to automate various tasks, including data collection from multiple sources. Upon receiving the user's request, a query message is sent to the LLM, which determines whether to collect additional data from one or more Application Programming Interfaces (APIs) or to generate a final response based on the existing message history. If additional data is needed, it is collected from the APIs and incorporated into the LLM's message history. Subsequently, the LLM generates a final response based on either the updated message history or the newly collected data. This final response is then communicated back to the user, ensuring accurate and contextually relevant interactions.

### TECHNICAL FIELD

The present disclosure relates to a method and system for automating chat-based interactions. More particularly, the present disclosure relates to an advanced method and system using large language models (LLMs) to enhance the efficiency and accuracy of chat-based interactions by dynamically integrating data from multiple sources and maintaining coherent conversation histories.

### BACKGROUND

The integration of language models into automated systems for chat-based interactions has been a rapidly growing area of innovation. Traditionally, chatbots and virtual assistants have relied on predefined rules and simple pattern-matching algorithms to interact with users. These systems typically utilize keyword recognition and scripted responses, which limit their ability to handle complex queries or adapt to new situations.

With advancements in natural language processing (NLP) and the development of sophisticated large language models (LLMs) like Generative Pre-trained Transformer-3 (GPT-3) and GPT-4, there has been a significant shift towards using machine learning models that can understand and generate human-like text. These models are capable of processing vast amounts of data, understanding context, and providing more accurate and relevant responses.

Despite these advancements, several challenges persist in the current state of the art. Firstly, regarding data integration and management, existing systems struggle with efficiently integrating data from multiple Application Programming Interfaces (APIs) and dynamically updating their internal knowledge base. This often leads to inconsistent or outdated responses, especially when dealing with rapidly changing information. Secondly, maintaining a coherent conversation over multiple interactions remains problematic. Many systems fail to accurately retain and utilize historical conversation data, leading to disjointed or irrelevant responses. Thirdly, implementing and scaling LLM-based chat systems across different domains and industries can be complex. Customizing these systems to cater to specific needs without extensive manual intervention remains a significant hurdle. Lastly, the computational resources required to run advanced LLMs can be substantial, making it challenging to optimize the performance of these models while ensuring timely responses.

In summary, the key challenges in the prior art include efficiently integrating and managing data from multiple APIs, maintaining coherent, and contextually accurate conversations over multiple interactions, implementing and scaling LLM-based systems across various domains without extensive customization efforts, and managing the substantial computational resources required to ensure timely and efficient performance.

Thus, there is a need to provide an advanced method and system using large language models (LLMs) to enhance the efficiency and accuracy of chat-based interactions.

### SUMMARY

The present disclosure relates to a method and a system for automating chat-based interactions. The disclosure aims to efficiently integrate data from multiple sources, including but not limited to various types of Application Programming Interfaces (APIs) to ensure that the responses are accurate and up-to-date. The disclosure maintains a coherent conversation history by updating and utilizing the collected data from APIs within the LLM's available message history. Further, the disclosure facilitates the deployment and customization of LLM-based chat systems using automated templates and curated tools and optimizes the performance and scalability of the LLM-based systems to ensure timely and resource-efficient responses.

In an embodiment, a method for automating chat-based interactions using a large language model (LLM) is disclosed. The method includes receiving, by an apparatus, one or more requests from a user, where the apparatus is configured to automate one or more tasks including collecting data from one or more sources. The method further comprises sending a query message to the LLM based on the user's request, where the LLM provides information on either collecting data from one or more APIs or returning a final response to the query message based on the available history of messages with the LLM. The method further comprises collecting data from the one or more APIs or sending a final response to the query message based on LLM's information. Based on the data collected from the one or more APIs, the method further comprises updating the collected data from the APIs to the available message history with the LLM and receiving a final response from the LLM based on at least one of the available message history with the LLM and the collected data from the one or more APIs. Furthermore, the method comprises sending the final response to the user.

In some embodiments, the one or more sources include at least one of Search API, Structured Query Language (SQL) API, and Graph API.

In some embodiments, using an API interaction toolkit include functions comprising one or more of list_api_servers, requests_get, and requests_post for collecting data from the one or more sources.

In some embodiments, storing history in a vector format for semantically relevant retrieval in a conversation vector database.

In some embodiments, accessing the LLM via endpoints includes one or more of open weight LLM Endpoint and proprietary LLM Endpoint.

In some embodiments, deploying an automated agentic Generative Artificial Intelligence (GenAI) template.

In some embodiments, deploying the agentic GenAI template comprises automatically setting up the necessary infrastructure for the chat-based interactions, utilizing one or more curated tools tailored to the chat-based interactions, and employing pre-built Extract Transform Load (ETL) pipelines for data processing.

In some embodiments, vectorizing and mapping the stored data.

In some embodiments, vectorizing and mapping the stored data comprises at least one of converting unstructured data into a usable format, preparing structured data using SQL, and creating time series data from telemetry.

In some embodiments, the LLM provides the information on collecting the data from the one or more APIs when the LLM lacks sufficient data corresponding to the query message.

In yet another embodiment, an apparatus for automating chat-based interactions using a large language model (LLM) is disclosed. The apparatus automates one or more tasks including collecting data from one or more sources. The apparatus receives one or more requests from a user and sends a query message to the LLM based on the user's request, where the LLM provides information on either collecting data from one or more Application Programming Interfaces (APIs) or returning a final response to the query message based on available history of messages with the LLM. The apparatus further collects data from the one or more APIs or sends a final response to the query message based on LLM's information. Based on the data collection, the apparatus updates the collected data from the APIs to the available message history with the LLM and receives a final response from the LLM based on at least one of the available message history with the LLM and the collected data from the one or more APIs. Furthermore, the apparatus sends the final response to the user.

In some embodiments, the one or more sources include at least one of search API, Structured Query Language (SQL) API, and graph API.

In some embodiments, using an API interaction toolkit includes functions comprising one or more of list_api_servers, requests_get, and requests_post for collecting data from the one or more sources.

In some embodiments, storing history in a vector format for semantically relevant retrieval in a conversation vector database.

In some embodiments, accessing the LLM via endpoints including one or more of open weight LLM Endpoint and proprietary LLM Endpoint.

In some embodiments, deploying an automated agentic Generative Artificial Intelligence (GenAI) template.

In some embodiments, deploying the agentic GenAI template by automatically setting up the necessary infrastructure for the chat-based interactions, utilizing one or more curated tools tailored to the chat-based interactions, and employing pre-built Extract Transform Load (ETL) pipelines for the data processing.

In some embodiments, vectoring and mapping the stored data by converting unstructured data into a usable format, preparing structured data using SQL, and creating time series data from telemetry.

In some embodiments, the LLM provides the information on collecting the data from the one or more APIs when the LLM lacks sufficient data corresponding to the query message.

In yet another embodiment, a non-transitory computer-readable medium having stored thereon computer-readable instructions that, when executed by a processor, cause the processor to execute a method for automating chat-based interactions using a large language model (LLM), comprising receiving one or more request from a user, where the apparatus is configured to automate one or more tasks including collecting data from one or more sources. The computer-readable instructions further cause the processor to send a query message to the LLM based on the user's request, where the LLM provides information on either collecting data from one or more Application Programming Interfaces (APIs) or returning a final response to the query message based on available history of messages with the LLM. The computer-readable instructions further cause the processor to collect data from the one or more APIs or send a final response to the query message based on LLM's information, and based on collecting, updating the collected data from the APIs to the available message history with the LLM. The computer-readable instructions further cause the processor to receive a final response from the LLM based on at least one of the available message history with the LLM and the collected data from the one or more APIs, and send the final response to the user.

The disclosed automated chat-based interactions method significantly enhances the user experience and system efficiency. By automating chat-based interactions using advanced language models, users can interact through various forms such as text, voice, and video, catering to diverse preferences and improving overall user engagement.

The Agent acts as a sophisticated intermediary, processing user requests and determining the appropriate actions to take. This agent seamlessly integrates with multiple components, including the Conversation Vector Database, the LLM Layer, and the API Interaction Toolkit, to provide comprehensive and accurate responses. The system's ability to dynamically update its internal knowledge base by collecting real-time data from external APIs ensures that responses are consistent and current.

Moreover, the use of endpoints like open weight LLM and proprietary LLM facilitates robust computational resources for processing complex language tasks, improving the accuracy, and relevance of the responses. The efficient management of interaction between the Agent and LLM endpoints optimizes computational resources, ensuring timely and efficient responses.

Additionally, the capability to store conversation history in a vector format allows for semantically relevant retrieval, maintaining coherence over multiple interactions. This integration and synthesis of data from diverse sources enable the Agent to provide contextually relevant responses, significantly enhancing the user's chat-based interaction experience. The deployment of automated agentic Generative Artificial Intelligence (GenAI) templates further streamlines the setup and customization process, making the system adaptable and efficient for various applications.

This summary is provided to describe select concepts in a simplified form that are further described in the detailed description. This summary is not intended to identify key or essential features of the claimed subject matter, nor is it intended to be used as an aid in determining the scope of the claimed subject matter.

These and other objectives and advantages of the present disclosure will become more apparent when reference is made to the following description.

### BRIEF DESCRIPTION OF DRAWINGS

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings in which:

FIG. 1 illustrates an architecture for a system that facilitates advanced chat-based interactions using various machine learning (ML) and natural language processing (NLP) tools, hosted within Docker containers for modularity and scalability according to an embodiment of the disclosure;

FIG. 2 illustrates a system architecture for automating chat-based interactions using large language models (LLM) according to an embodiment of the disclosure;

FIG. 3 illustrates a flowchart related to automating chat-based interactions using a language model according to an embodiment of the disclosure;

FIG. 4 illustrates a system for automating chat-based interactions using a language model according to an embodiment of the disclosure; and

FIG. 5 illustrates a schematic diagram of a communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

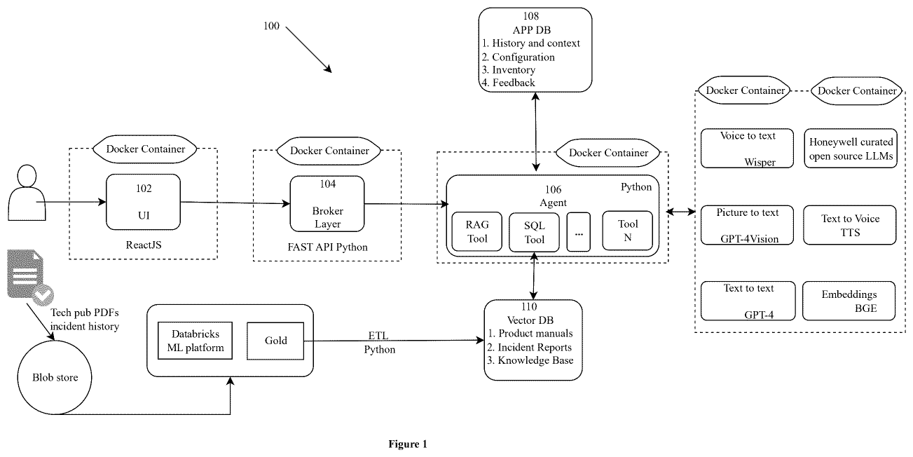

FIG. 1 illustrates an architecture for an automated chat-based system 100, hereinafter interchangeably referred to as system 100, that facilitates advanced chat-based interactions leveraging various machine learning (ML) and natural language processing (NLP) tools, hosted within docker containers for modularity and scalability, according to an embodiment of the disclosure.

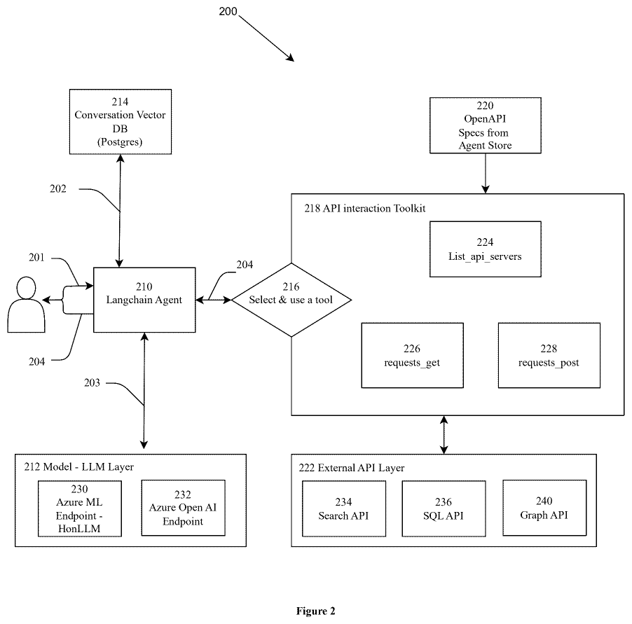

The system 100 includes key components including a User Interface (UI) 102, a broker layer 104, an agent layer 106, an application database (App DB) 108, and a vector Database (Vector DB) 110. The agent layer 106 is hereinafter interchangeably referred to as “Agent” and has been referred to with reference numeral 210 in FIG. 2, according to an embodiment of the disclosure.

The UI 102 serves as the entry point for user interactions is being developed using ReactJS. The ReactJS is a popular JavaScript library used for building UIs, particularly single-page applications, to ensure a fast and responsive user experience by creating reusable UI components. The UI 102 captures a user requests in various forms such as text, voice, video, or any combination thereof. For instance, a user may type a query, speak into a microphone for voice commands, or upload a video containing a request to initiate the chat-based interaction. In an embodiment, the UI component is hosted in a docker container to ensure a consistent and isolated runtime environment.

The broker layer 104 acts as an intermediary between the UI 102 and the agent layer 106. In an embodiment, the broker layer 104 is implemented with FAST API in Python. The FAST API stands for Fast Application Programming Interface, which is a modern, fast (high-performance) web framework for building APIs with Python 3.6+ based on standard Python type hints. This is designed to be easy to use and provides automatic interactive API documentation. The broker layer 104 routes the user's requests to the appropriate processing components. For example, when any user asks for troubleshooting steps for a malfunctioning device, the broker layer 104 forwards this request to the agent layer 106 for further processing.

The agent layer 106 receives the user's requests and hosts various tools necessary for processing the request, including Retrieval-Augmented Generation (RAG) Tool, SQL Tool, and other specialized tools to handle different types of data processing. For instance, if the user requests information from a product manual, the agent layer 106 may use the RAG tool to fetch relevant sections from the vector DB 110. The vector DB 110 stores product manuals, incident reports, and a knowledge base in a vectorized format. This format supports efficient semantic search and retrieval, ensuring that the agent layer 106 can quickly access relevant information. For example, if a user queries about previous incident reports related to a specific error code, the agent layer 106 retrieves vectorized data from the vector DB 110.

The application database 108, hereinafter interchangeably referred to as “APP DB”, stores history and context, configurations, inventory, and user feedback ensuring that the system 100 maintains coherent and contextually accurate conversations over multiple interactions. For example, if a user has previously asked about a specific device configuration, this context is stored and used in future interactions to provide more accurate and relevant responses.

The Extract Transform Load (ETL) process, implemented in Python, ingests data from a blob store containing technical publications and incident history, in an embodiment. This data is processed on the data processing platform and stored in the vector DB 110. New technical manuals uploaded to the blob store are processed and vectorized, then stored in the vector DB 110 for future retrieval.

In an embodiment, the openAPI specs provide necessary API specifications, enabling the agent layer 106 to interact with various external services effectively. The agent layer 106 can dynamically adapt to new APIs based on these specifications, expanding its capabilities without manual updates.

In an embodiment, the system 100 includes an External API Layer consisting of various external APIs such as the Search API, SQL API, and Graph API, providing additional data sources to enrich the Agent's responses. The Search API can be used to fetch the latest industry trends, while the SQL API can retrieve data from a relational database. Various tools are hosted in docker containers for scalability and modular deployment, which include whisper (Voice to Text) which converts voice commands into text, GPT-4Vision (Picture to Text) which processes images and extracts text, TTS (Text to Voice) which converts text responses back into speech, GPT-4 (Text to Text) that processes and generates text-based responses, and embeddings BGE that embeds text for semantic understanding.

The exemplary working of the system 100 can be illustrated as follows: A user speaks a command, which a microphone/Whisper having a convertor converts to text. The GPT-4 processes this text and generates a response, which the TTS tool converts back to speech. For example, consider a user seeking help with a device malfunction. In such a scenario, the user interaction includes speaking, “Why is my device overheating?” into the UI 102. The broker layer 104 forwards this voice data to the agent layer 106. Further, the voice is converted to text, and the agent layer 106 uses the RAG tool to search the vector DB 110 for relevant incident reports and product manuals. Further, the vector DB 110 returns relevant documents which the RAG tool processes to generate a coherent response. Finally, the generated text response is converted back to speech by TTS, and the user hears, “Your device may be overheating due to blocked ventilation. Please ensure the vents are clear.”

The system 100 provides accurate, contextually relevant responses to user queries. The use of docker containers ensures modularity and scalability, while the incorporation of ML and NLP tools enables the system 100 to handle a wide range of user interactions efficiently.

FIG. 2 illustrates an automated chat-based interactions system 200, hereinafter interchangeably referred to as a ‘system 200’, designed for automating chat-based interactions using large language models (LLMs) according to an embodiment of the disclosure. This system 200 integrates various components, including an API interaction toolkit 218, an LLM layer 212, an external API layer 222, a conversation vector database 214, and an agent 210, hereinafter interchangeably referred to as ‘an agent 210’, to enhance the efficiency and accuracy of chat-based interactions.

The process begins with a user initiating a request at step 201. This request can be in various forms, including voice, text, video, or any combination thereof. For example, a user may ask a question via a voice command, type a query into a chat interface, or send a video message describing their issue. These requests are directed towards the agent 210 responsible for managing the interaction. Users communicate with the agent 210 through one or more user interface. In an embodiment, the interface can include a voice recognition system for handling spoken requests, a text-based chat application for written queries, or a multimedia platform capable of processing video inputs. In an embodiment, the system 200 utilizes the UI 102 discussed in FIG. 1 above for user interface purposes.

The agent 210 acts as an intermediary to processing the user's request and determining the appropriate actions to take. For instance, if a user submits a video describing a problem with their device, the agent 210 can extract relevant information from the video and use it to form a query. In an embodiment, the agent 210 communicates with multiple components, including, but not limited to, the conversation vector database 214, the LLM layer 212, and the API interaction toolkit 218. For example, the agent 210 might retrieve historical interaction data from the conversation vector database 214 to maintain context, query the LLM layer 212 to generate a response based on advanced language models, and utilize the API interaction toolkit 218 to fetch additional data from external sources, ensuring a comprehensive and accurate reply to the user's request.

Further, the agent 210 sends a query message to the LLM layer 212 based on the user's request, in step 203. These query messages can vary widely, encompassing straightforward questions, complex multi-part inquiries, requests for detailed explanations, or commands for specific actions. For example, a user might ask for the latest news headlines, request detailed steps to troubleshoot a device issue, or inquire about a weather forecast for a specific location.

In an embodiment, the LLM layer 212 decides whether to collect data from one or more Application Programming Interfaces (APIs) or return a final response to the query message based on the available history of messages with the LLM 212. The LLM layer 212 evaluates the completeness and relevance of the information already present in the conversation history. If the LLM 212 detects that additional data is needed to provide a precise or updated response, the LLM 212 will initiate data collection from the relevant APIs.

The LLM Layer 212 includes endpoints for accessing LLMs, including, but not limited to open weight LLM Endpoint 230 and proprietary LLM Endpoint 232. These endpoints 230 and 232 facilitate interaction with advanced language models hosted on platforms like Microsoft Azure providing robust computational resources for processing complex language tasks. The Agent 210 sends queries to these endpoints 230 and 232 to generate responses based on the user's request and the available conversation history. For instance, the open weight LLM Endpoint 230 might be used for tasks requiring specialized machine learning models, while the proprietary LLM Endpoint 232 could be leveraged for generating human-like text responses using state-of-the-art language models such as Generative Pre-trained Transformer-4 (GPT-4).

Alternatively, the Agent 210 can also decide whether to collect data from APIs or send a final response directly. The Agent 210 may send a final response based on the information available with the conversation vector DB 214. The agent 210 evaluates the query message in conjunction with the available conversation history and any pre-existing data. If the agent 210 determines that the information on hand is sufficient to formulate an accurate and relevant response, the agent 210 will proceed to deliver the final response to the user without querying the LLM layer 212. This embodiment enhances the system's efficiency by reducing the need for unnecessary data collection and processing.

The conversation vector database 214 stores conversation history in a vector format using a structured database which is used by the Agent 210 to prepare the final response. Examples of conversation history might include previous user interactions, such as a user asking about the status of an order followed by related questions on delivery details, or a user querying for restaurant recommendations followed by questions on menu details and reservation options. The structured database allows for semantically relevant retrieval, ensuring coherent conversation continuity by maintaining context over multiple interactions, thus enabling the system 200 to provide more accurate and contextually appropriate responses.

For collecting the data from the APIs, the agent 210 communicates with the API interaction toolkit 218, step 204. The communication methods between the agent 210 and the API interaction toolkit 218 can vary and include direct function calls, RESTful API requests and inter-process communication (IPC) mechanisms ensuring flexible and efficient data exchange. In some embodiments, the communication can be asynchronous, allowing the agent 210 to continue processing other tasks while waiting for API responses.

The API interaction toolkit 218 interacts with the external API layer 222 to collect data as needed. For example, when a user asks a complex question that requires data from multiple sources, the Agent 210, at step 204, will first consult the openAPI specs from the agent store 220 to understand the required APIs. The agent 210 then uses List_api_servers 224 to identify available servers, followed by making appropriate GET requests using requests_get 226 or POST requests using requests_post 228 to the identified APIs.

The API interaction toolkit 218 provides various functions for interacting with external APIs. The key components include the List_api_servers 224, requests_get 226, and requests_post 228. The List_api_servers 224 function lists the available API servers that the system can query. This is crucial for maintaining an updated catalogue of API endpoints that can be utilized for data collection. In some embodiments, the List_api_servers 224 can dynamically update based on newly integrated APIs, providing real-time adaptability to the agent 210.

The requests_get 226 function is used for making GET requests to external APIs. This function retrieves data from the specified endpoints, typically used for fetching information such as user data, weather updates, or stock prices. For instance, if the user requests the current weather, the agent 210 will use requests_get 226 to call a weather API and fetch the necessary data.

The requests_post 228 function is for making POST requests to external APIs. This function sends data to the specified endpoints, often used for submitting forms, uploading files, or updating records in a database. An example scenario could be the user updating their profile information, where the agent 210 uses requests_post 228 to send the updated data to the relevant API.

The API interaction toolkit 218 is selected and used by the Agent 210 as necessary, by using the tool select and use 216, to gather additional data required for generating accurate responses. The selection process involves the agent 210 evaluating the type of data needed and choosing the appropriate function from the Toolkit 218. For example, if the agent 210 needs to retrieve data, the agent will select requests_get 226, whereas for submitting data, it will opt for requests_post 228.

An exemplary embodiment involves a user asking for a detailed report on recent financial transactions. The agent 210 recognizing that this requires both retrieving historical data and possibly submitting a new query for the most recent transactions, will first use the List_api_servers 224 to identify the appropriate financial APIs. The agent 210 will then use the requests_get 226 to fetch historical transaction data and the requests_post 228 to submit a query for the latest transactions. By employing the tool select and use 216, the agent 210 ensures the utilization of the right functions from the Toolkit 218, thus efficiently gathering all necessary data to generate an accurate and comprehensive response.

The openAPI specs from agent store 220 provide specifications for various APIs, enabling the agent 210 to understand and interact with different external services effectively. The openAPI specs detail the structure, endpoints, methods, and data formats required to communicate with each API, ensuring seamless integration and interaction. This allows the agent 210 to dynamically adapt to and leverage a wide array of external services without extensive pre-programming.

The external API layer 222 includes several key APIs such as a search API 234, a SQL API 236, and a graph API 240. The search API allows the agent 210 to perform search operations over a vast array of data sources. For example, if a user asks for the latest news articles, the agent 210 can use the Search API to query news databases and return relevant articles. The Search API can be utilized through the requests_get 226 function to retrieve information based on search queries.

The SQL API 236 enables interaction with databases using Structured Query Language (SQL). For instance, if a user requests detailed sales reports or customer information stored in a relational database, the agent 210 can use the SQL API to execute queries and fetch the required data. The agent 210 might use the requests_get 226 for SELECT queries or requests_post 228 for INSERT, UPDATE, or DELETE operations.

The graph API 240 facilitates querying and updating graph-based data structures. The graph API 240 is particularly useful for scenarios involving social networks, recommendation systems, or any data represented as a graph. For example, if a user wants to know the shortest path between two points in a transportation network, the agent 210 can use the Graph API to compute and retrieve this information.

In an embodiment, the openAPI specs from agent store 220 inform the Agent 210 about the required authentication, available endpoints, parameters, and expected responses for each API, ensuring that the agent 210 can interact with these APIs effectively.

In an exemplary embodiment, consider a user inquiring about the latest trends in a specific industry. The Agent 210 might first use the search API 234 to retrieve recent articles and reports. If the inquiry also involves detailed statistical data stored in a relational database, the agent 210 will utilize the SQL API 236 to execute the necessary queries. Additionally, if the user asks about the interconnections between various companies within that industry, the graph API 240 will be employed to retrieve and analyze this relational data.

By integrating and synthesizing data from these diverse sources, the Agent 210 can provide comprehensive, accurate, and contextually relevant responses, significantly enhancing the user's chat-based interaction experience.

In an embodiment, the system 200 efficiently integrates data from various APIs to ensure responses are accurate and up-to-date, leveraging the API interaction toolkit 218. Further, by storing conversation history in a vector format, the system 200 maintains coherence over multiple interactions, providing contextually relevant responses.

In an embodiment, the Agent 210 can be tailored to specific domains using curated tools and automated templates, facilitating easy deployment and customization. Further, the system 200 optimizes the use of computational resources by managing the interaction between the Agent 210 and LLM endpoints ensuring timely and efficient responses.

In an embodiment, the ability to dynamically update the internal knowledge base by collecting real-time data from external APIs addresses the challenge of providing consistent and current responses.

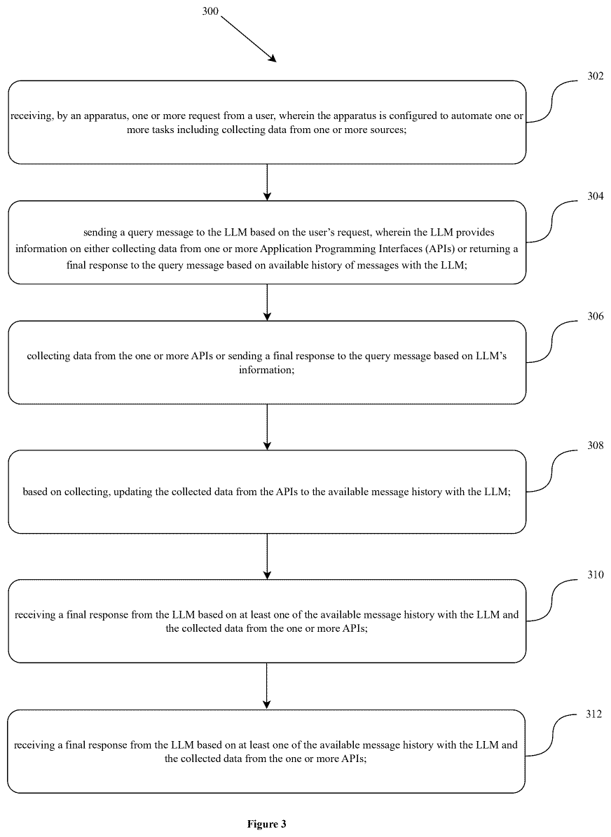

FIG. 3 illustrates a flowchart related to automating chat-based interactions using a language model according to an embodiment of the disclosure. The method begins with the initial step of receiving one or more requests from a user through an apparatus, such as an agent, which is capable of handling various forms of input including text, voice, video, or any combination thereof, step 302. The user interface (UI) captures these requests in different formats. For instance, a user may type a query, speak into a microphone for voice commands, or upload a video containing a request to initiate the chat-based interaction. In some embodiments, the UI component is hosted in a docker container to ensure a consistent and isolated runtime environment.

Upon receiving the user request, the agent processes these inputs and determines the appropriate actions to take. The agent serves as an intermediary, extracting relevant information from the user input, such as a video describing a problem, and formulating a query. The agent communicates with multiple components, including the conversation vector database, the LLM layer, and the API interaction toolkit. For example, the agent might retrieve historical interaction data from the conversation vector database to maintain context, query the LLM Layer to generate a response based on advanced language models, and utilize the API interaction toolkit to fetch additional data from external sources. This ensures a comprehensive and accurate reply to the user's request.

Following this, the method involves sending a query message to the LLM based on the user's request, step 304. The LLM then evaluates whether to collect additional data from APIs or to return a final response based on the available conversation history. This decision is based on the completeness and relevance of the information already present in the conversation history. If the LLM detects that additional data is needed to provide a precise or updated response, the LLM initiates data collection from the relevant APIs. In an embodiment, the conversation history is stored in a vector format for semantically relevant retrieval in the conversation vector database.

The LLM includes endpoints for accessing large language models, such as open weight LLM Endpoint and proprietary LLM Endpoint. These endpoints facilitate interaction with advanced language models hosted on platforms like Microsoft Azure, providing robust computational resources for processing complex language tasks. The agent sends queries to these endpoints to generate responses based on the user's request and the available conversation history. For instance, the open weight LLM Endpoint might be used for tasks requiring specialized machine learning models, while the proprietary LLM Endpoint could be leveraged for generating human-like text responses using state-of-the-art language models like Generative Pre-trained Transformer-4 (GPT-4).

In an alternative embodiment, the agent can decide whether to collect data from APIs or send a final response directly. The agent evaluates the query message in conjunction with the available conversation history and any pre-existing data. If the agent determines that the information on hand is sufficient to formulate an accurate and relevant response, the agent will proceed to deliver the final response to the user without querying the LLM layer. This embodiment enhances the system's efficiency by reducing the need for unnecessary data collection and processing.

The method further involves collecting data from one or more APIs or sending a final response based on the LLM's information, step 306. This step ensures that the system has access to the most current and relevant data to provide an accurate response to the user. The collected data from the APIs is then updated to the conversation history with the LLM, step 308. This process ensures that the LLM has a comprehensive understanding of the conversation context, improving the accuracy and relevance of future interactions.

For collecting data from APIs, the agent communicates with the API interaction toolkit. The communication methods between the agent and the API Interaction Toolkit can vary, including direct function calls, RESTful API requests, and inter-process communication (IPC) mechanisms, ensuring flexible and efficient data exchange. In some embodiments, the communication can be asynchronous, allowing the agent to continue processing other tasks while waiting for API responses.

The API interaction toolkit provides various functions for interacting with external APIs. The key components include List_api_servers, requests_get, and requests_post. The List_api_servers function lists the available API servers that the system can query. This is crucial for maintaining an updated catalog of API endpoints that can be utilized for data collection. In some embodiments, the List_api_servers can dynamically update based on newly integrated APIs, providing real-time adaptability to the agent.

The requests_get function is used for making GET requests to external APIs. This function retrieves data from the specified endpoints, typically used for fetching information such as user data, weather updates, or stock prices. For instance, if the user requests the current weather, the agent will use requests_get to call a weather API and fetch the necessary data.

Lastly, the requests_post function is for making POST requests to external APIs. This function sends data to the specified endpoints, often used for submitting forms, uploading files, or updating records in a database. An example scenario could be the user updating their profile information, where the agent uses the requests_post to send the updated data to the relevant API.

The agent selects and uses these functions as necessary, evaluating the type of data needed and choosing the appropriate function from the toolkit. For example, if the agent needs to retrieve data, it will select requests_get, whereas for submitting data, it will opt for requests_post. This selection process ensures that the agent gathers all the necessary data required for generating accurate responses.

The method concludes with receiving a final response from the LLM based on at least one of the available message history with the LLM and the collected data from the APIs, and sending this final response to the user, steps 310 and 312. This comprehensive approach ensures that the responses are accurate, contextually relevant, and up-to-date.

In some embodiments, the method further involves deploying an automated agentic Generative Artificial Intelligence (GenAI) template. This includes setting up the necessary infrastructure for chat-based interactions, utilizing curated tools tailored to these interactions, and employing pre-built Extract Transform Load (ETL) pipelines for data processing. Additionally, the method may involve vectorizing and mapping stored data, converting unstructured data into a usable format, preparing structured data using SQL, and creating time series data from telemetry to enhance data usability and interaction efficiency. These additional steps ensure that the system remains robust, adaptable, and capable of delivering high-quality interactions over time.

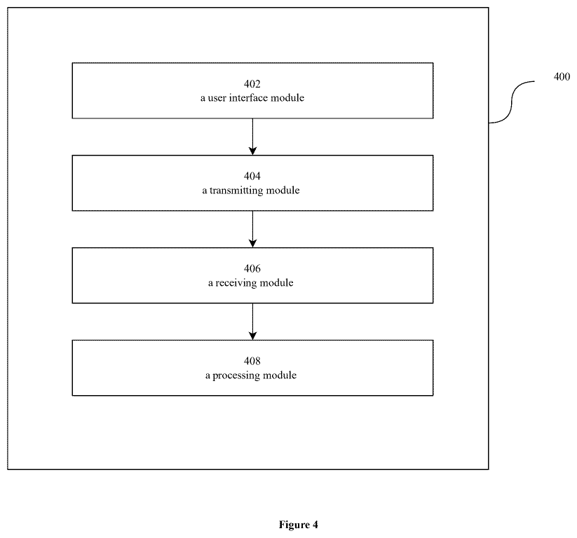

FIG. 4 illustrates a system 400 for automating chat-based interactions using a language model according to an embodiment of the disclosure. The system 400, such as the Agent, encompasses several key components, including a User Interface (UI) module 402, a transmitting module 404, a receiving module 406, and a processing module 408. Each module plays a crucial role in the overall process of implementing automated chat-based interactions.

A user inputs requests through the UI module 402, which is capable of handling various forms of input, including text, voice, video, or any combination thereof. The UI captures these requests in different formats. For instance, a user may type a query, speak into a microphone for voice commands, or upload a video containing a request to initiate the chat-based interaction. In some embodiments, the UI component is hosted in a docker container to ensure a consistent and isolated runtime environment.

Upon receiving the user request, the processing module 408 processes these inputs and determines the appropriate actions to take. The Agent comprising the processor serves as an intermediary, extracting relevant information from the user input, such as a video describing a problem, and formulating a query. The Agent communicates with multiple components, including the Conversation Vector Database, the LLM Layer, and the API Interaction Toolkit, to implement the chat-based interaction of the user. For example, it might retrieve historical interaction data from the conversation vector database to maintain context, query the LLM Layer to generate a response based on advanced language models, and utilize the API interaction toolkit to fetch additional data from external sources. This ensures a comprehensive and accurate reply to the user's request.

Further, the transmitting module 404 sends a query message to the LLM based on the user's request. The LLM then evaluates whether to collect additional data from APIs or to return a final response based on the available conversation history. This decision is based on the completeness and relevance of the information already present in the conversation history. If the LLM detects that additional data is needed to provide a precise or updated response, it initiates data collection from the relevant APIs. In an embodiment, the conversation history is stored in a vector format for semantically relevant retrieval in a conversation vector database.

The LLM includes endpoints for accessing large language models, such as open weight LLM Endpoint and proprietary LLM Endpoint. These endpoints facilitate interaction with advanced language models hosted on platforms like Microsoft Azure, providing robust computational resources for processing complex language tasks. The agent sends queries to these endpoints to generate responses based on the user's request and the available conversation history. For instance, the open weight LLM Endpoint might be used for tasks requiring specialized machine learning models, while the proprietary LLM Endpoint could be leveraged for generating human-like text responses using state-of-the-art language models like Generative Pre-trained Transformer-4 (GPT-4).

In an alternative embodiment, the agent can decide whether to collect data from APIs or send a final response directly. The agent evaluates the query message in conjunction with the available conversation history and any pre-existing data. If the agent determines that the information on hand is sufficient to formulate an accurate and relevant response, the agent will proceed to deliver the final response to the user without querying the LLM layer. This embodiment enhances the system's efficiency by reducing the need for unnecessary data collection and processing.

The processing module 408 further collects data from one or more APIs or sends a final response based on the LLM's information. This step ensures that the system has access to the most current and relevant data to provide an accurate response to the user. The collected data from the APIs is then updated to the conversation history with the LLM. This process ensures that the LLM has a comprehensive understanding of the conversation context, improving the accuracy, and relevance of future interactions.

For collecting data from APIs, the receiving module 406 communicates with the API Interaction Toolkit. The receiving module 406 receives RESTful API requests and inter-process communication (IPC) mechanisms, ensuring flexible and efficient data exchange. In some embodiments, the communication can be asynchronous, allowing the agent to continue processing other tasks while waiting for API responses.

The API Interaction Toolkit provides various functions for interacting with external APIs. The key components include List_api_servers, requests_get, and requests_post. The processing module 408 selects and uses these functions as necessary, evaluating the type of data needed and choosing the appropriate function from the Toolkit. For example, if the agent needs to retrieve data, the agent will select the requests_get, whereas for submitting data, the agent will opt for requests_post. This selection process ensures that the agent gathers all the necessary data required for generating accurate responses.

The receiving module 406 furthermore receives a final response from the LLM based on at least one of the available message history with the LLM and the collected data from the APIs. Then, the transmitting module 404 sends this final response to the user. This comprehensive approach ensures that the responses are accurate, contextually relevant, and up-to-date.

In some embodiments, the method further involves deploying an automated agentic Generative Artificial Intelligence (GenAI) template. This includes setting up the necessary infrastructure for chat-based interactions, utilizing curated tools tailored to these interactions, and employing pre-built Extract Transform Load (ETL) pipelines for data processing. Additionally, the method may involve vectorizing and mapping stored data, converting unstructured data into a usable format, preparing structured data using SQL, and creating time series data from telemetry to enhance data usability and interaction efficiency. These additional steps ensure that the system remains robust, adaptable, and capable of delivering high-quality interactions over time.

The disclosed automated chat-based interactions method significantly enhances the user experience and system efficiency. By automating chat-based interactions using advanced language models, users can interact through various forms such as text, voice, and video, catering to diverse preferences and improving overall user engagement.

The Agent acts as a sophisticated intermediary, processing user requests, and determining the appropriate actions to take. This agent seamlessly integrates with multiple components, including the conversation vector database, the LLM Layer, and the API interaction toolkit to provide comprehensive and accurate responses. The system's ability to dynamically update its internal knowledge base by collecting real-time data from external APIs ensures that responses are consistent and current.

Moreover, the use of endpoints like open weight LLM and proprietary LLM facilitates robust computational resources for processing complex language tasks, improving the accuracy, and relevance of the responses. The efficient management of interaction between the agent and LLM endpoints optimizes computational resources, ensuring timely and efficient responses.

Additionally, the capability to store conversation history in a vector format allows for semantically relevant retrieval, maintaining coherence over multiple interactions. This integration and synthesis of data from diverse sources enable the agent to provide contextually relevant responses, significantly enhancing the user's chat-based interaction experience. The deployment of automated agentic Generative Artificial Intelligence (GenAI) templates further streamlines the setup and customization process, making the system adaptable and efficient for various applications.

In yet another embodiment, a non-transitory computer-readable medium having stored thereon computer-readable instructions that, when executed by a processor, cause the processor to execute a method for automating chat-based interactions using a large language model (LLM), comprising receiving one or more request from a user, wherein the apparatus is configured to automate one or more tasks including collecting data from one or more sources. The computer-readable instructions further cause the processor to sending a query message to the LLM based on the user's request, wherein the LLM provides information on either collecting data from one or more Application Programming Interfaces (APIs) or returning a final response to the query message based on available history of messages with the LLM. The computer-readable instructions further cause the processor to collect data from the one or more APIs or sending a final response to the query message based on LLM's information, and based on collecting, updating the collected data from the APIs to the available message history with the LLM. The computer-readable instructions further cause the processor to receive a final response from the LLM based on at least one of the available message history with the LLM and the collected data from the one or more APIs, and sending the final response to the user.

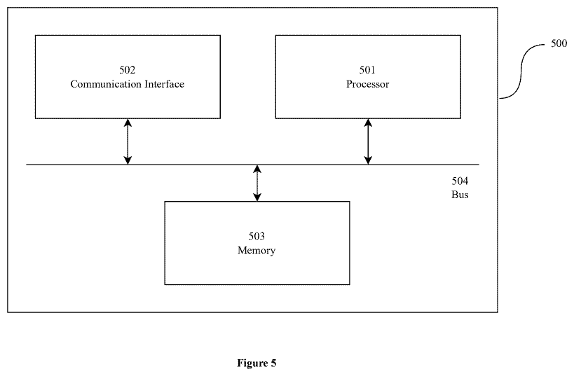

FIG. 5 illustrates a schematic diagram of another communication apparatus 500 according to an embodiment of the disclosure. The communication apparatus 500 includes a processor 501, a communication interface 502, and a memory 503. The processor 501, the communication interface 502, and the memory 503 may be connected to each other via a bus 504. The bus 504 may be a peripheral component interconnect (peripheral component interconnect, PCI) bus, an extended industry standard architecture (extended industry standard architecture, EISA) bus, or the like. The bus 504 may be classified into an address bus, a data bus, a control bus, and the like. For ease of representation, the bus is represented by using only one line in FIG. 5, but it does not indicate that there is only one bus or one type of bus. The processor 501 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 503 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or the another programmable data processing apparatus, a function/operation specified in the flowchart and/or the block diagram is implemented. The program code may be completely executed on a computer, partially executed on a computer, independently performed as a software package, partially executed on a computer and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random access memory (RAM), a read-only memory (ROM), an erasable programmable read-only memory (EPROM or flash memory), an optical storage device, a magnetic storage device, or any suitable combination thereof.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

It may further be advantageous to set forth definitions of certain words and phrases used throughout this patent document. The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The foregoing detailed description is merely exemplary in nature and is not intended to limit the subject matter of the application and uses thereof. Furthermore, there is no intention to be bound by any theory presented in the preceding background, brief summary, or detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

We claim:

1. A method for automating chat-based interactions using a large language model (LLM), comprising:
receiving, by an apparatus, one or more requests from a user, wherein the apparatus is configured to automate one or more tasks including collecting data from one or more sources;
sending a query message to the LLM based on the user's request, wherein the LLM provides information on either collecting data from one or more Application Programming Interfaces (APIs) or returning a final response to the query message based on available history of messages with the LLM;
collecting data from the one or more APIs or sending a final response to the query message based on LLM's information;
based on collecting, updating the collected data from the APIs to the available message history with the LLM;
receiving a final response from the LLM based on at least one of the available message history with the LLM and the collected data from the one or more APIs; and
sending the final response to the user.

2. The method as claimed in claim 1, wherein the one or more sources include at least one of:
Search API;
Structured Query Language (SQL) API; and
Graph API.

3. The method as claimed in claim 1, further comprising using an API interaction toolkit including functions comprising one or more of list_api_servers, requests_get, and requests_post for collecting data from the one or more sources.

4. The method as claimed in claim 1, further comprising storing history in a vector format for semantically relevant retrieval in a conversation vector database.

5. The method as claimed in claim 1, further comprising accessing the LLM via endpoints including one or more of open weight LLM Endpoint and proprietary LLM Endpoint.

6. The method as claimed in claim 1, further comprising deploying an automated agentic Generative Artificial Intelligence (GenAI) template.

7. The method as claimed in claim 6, wherein deploying the agentic GenAI template comprises:
automatically setting up the necessary infrastructure for the chat-based interactions;
utilizing one or more curated tools tailored to the chat-based interactions; and
employing pre-built Extract Transform Load (ETL) pipelines for data processing.

8. The method as claimed in claim 1, further comprising vectorizing and mapping the stored data.

9. The method as claimed in claim 8, wherein vectorizing and mapping the stored data comprises at least one of:
converting unstructured data into a usable format;
preparing structured data using SQL; and
creating time series data from telemetry.

10. The method as claimed in claim 1, wherein the LLM provides the information on collecting the data from the one or more APIs when the LLM lacks sufficient data corresponding to the query message.

11. An apparatus for automating chat-based interactions using a large language model (LLM), wherein the apparatus automates one or more tasks including collecting data from one or more sources, and the apparatus is configured to:
receive one or more requests from a user;
send a query message to the LLM based on the user's request, wherein the LLM provides information on either collecting data from one or more Application Programming Interfaces (APIs) or returning a final response to the query message based on available history of messages with the LLM;
collect data from the one or more APIs or send a final response to the query message based on LLM's information;
based on collection, update the collected data from the APIs to the available message history with the LLM;
receive a final response from the LLM based on at least one of the available message history with the LLM and the collected data from the one or more APIs; and
send the final response to the user.

12. The apparatus as claimed in claim 11, wherein the one or more sources include at least one of:
search API;
Structured Query Language (SQL) API; and
graph API.

13. The apparatus as claimed in claim 11, wherein the apparatus further configured to use an API interaction toolkit including functions comprising one or more of list_api_servers, requests_get, and requests_post for collecting data from the one or more sources.

14. The apparatus as claimed in claim 11, wherein the apparatus further configured to store history in a vector format for semantically relevant retrieval in a conversation vector database.

15. The apparatus as claimed in claim 11, wherein the apparatus further configured to access the LLM via endpoints including one or more of open weight LLM Endpoint and proprietary LLM Endpoint.

16. The apparatus as claimed in claim 11, wherein the apparatus further configured to deploy an automated agentic Generative Artificial Intelligence (GenAI) template.

17. The apparatus as claimed in claim 16, wherein the apparatus is configured to deploy the agentic GenAI template by:
automatically setting up the necessary infrastructure for the chat-based interactions;
utilizing one or more curated tools tailored to the chat-based interactions; and
employing pre-built Extract Transform Load (ETL) pipelines for the data processing.

18. The apparatus as claimed in claim 11, wherein the apparatus further configured to vector and map the stored data by:
converting unstructured data into a usable format;
preparing structured data using SQL; and
creating time series data from telemetry.

19. The apparatus as claimed in claim 11, wherein the LLM provides the information on collecting the data from the one or more APIs when the LLM lacks sufficient data corresponding to the query message.

20. A non-transitory computer-readable medium having stored thereon computer-readable instructions that, when executed by a processor, cause the processor to execute a method for automating chat-based interactions using a large language model (LLM), comprising:
receiving, by an apparatus, one or more requests from a user, wherein the apparatus is configured to automate one or more tasks including collecting data from one or more sources;
sending a query message to the LLM based on the user's request, wherein the LLM provides information on either collecting data from one or more Application Programming Interfaces (APIs) or returning a final response to the query message based on available history of messages with the LLM;
collecting data from the one or more APIs or sending a final response to the query message based on LLM's information;
based on collecting, updating the collected data from the APIs to the available message history with the LLM;
receiving a final response from the LLM based on at least one of the available message history with the LLM and the collected data from the one or more APIs; and
sending the final response to the user.
